(19) United States
(12) Patent Application Publication
(10) Pub. No.: US 2002/0176795 A1
(43) Pub. Date: Nov. 28, 2002

(54) Impregnated chipboard segments

(76) Inventor: Jeffrey Sorensen, Cherry Valley, IL (US)

Correspondence Address: Basil E. Demeur, KNECHTEL, DEMEUR & SAMLAN,, 130 South Oak Park Avenue, Oak Park, IL, 60302, US

(21) Appl. No.: 09/864,677

(22) Filed: May 24, 2001

(51) Int. Cl. C23F 11/00; B01J 7/00

(52) U.S. Cl. 422/7; 422/8

(57) ABSTRACT

A corrosion inhibiting device form in chipboard segments which can fit into storage enclosures intended to store metallic devices a chipboard segment is created by spray coating any corrosion inhibiting material carried in a fluid carrier onto one of the surfaces of the chipboard sheet, drying the sheet, and then reversing the sheet and spraying the corrosion inhibiting material in a fluid carrier onto the opposed surface of the chipboard sheet. The sheet is then dried a second time and allows the corrosion inhibiting material to impregnate the fibers of the chipboard material and become impregnated within the confines of the chipboard segment. The chipboard segment may also be provided with a clay coat on the one surface thereof, the clay coating being permeable but smooth in nature, thereby to permit indicia to be imprinted thereon. The clay coating will co-act with the chipboard segment and permit the corrosion inhibiting material to permeate through the clay coating in order to function within the confines of the environment of a storage box containing metallic objects.

### I. FIELD OF THE INVENTION

The present invention relates to corrosion inhibitors, and more particularly, to volatile corrosion inhibiting chipboard pieces intended for storage boxes containing metallic objects.

### II. BACKGROUND OF THE INVENTION

Corrosion inhibitors are well known in the industry. These types of devices retard the corrosive effects of moisture and other destructive environmental elements. Corrosion inhibitors are generally of two types, namely contact and volatile. Contact corrosion inhibitors protect surfaces of various items from the destructive nature of corrosives which lay in contact with the item's surface, and volatile corrosion inhibitors protect an item surface from the corrosive chemicals and vapors.

Corrosion inhibitors are particularly suited to retarding the pitting and tarnishing of metal objects. Most individuals are familiar with volatile corrosion inhibitors, also known as VCI's in the form of desiccant packets found in packing materials of metal objects and electronics. Corrosion inhibitors may also take the form of chemicals or other oils which are used to coat an item and thereby protect it from the corrosive effects of water vapor particularly.

Until now, corrosion inhibitors have been used almost exclusively only by original equipment manufacturers when packaging their goods at the factory. Corrosion inhibitors are not generally available to any user of a product despite the fact that it is after the end user has purchased a product that it is exposed to the most severe environmental conditions. Hence, it is fairly common for the end consumer to discard the desiccant or other form of corrosion inhibitor found in the packing materials of the product after the product has been opened. As a result, with time, rust and pitting will generally affect any metallic object as it is used over the years by the end consumer.

This effect is especially noticeable in connection with sports equipment such as fishing tackle boxes, golf clubs, other metallic implements used in sports, as well as in connection with items such as tools and the like stored in garages or in other environments where moisture and water vapor exists. For example, tools contained in a plastic or other water proof container will often time entrap moisture therein when used in a moisture laden environment. Hence, despite the fact that the container may be waterproof, once the end user is using the tools and has the container open, and then closes the container upon completion of his task, water vapor is entrapped in the container and will, in time, cause corrosion of the steel tools in the tool box. Even when tools are coated with a chemical or other oil in order to protect them from corrosion, such a coating will usually wear away as the end user uses the tool, and in time, the tool will be attacked by the corrosive effects of rust.

It is therefore considered important to provide a convenient and easy to use volatile corrosion inhibiting device for use in connection with metallic objects, especially those stored in boxes such as tackle boxes or tool boxes, in order to protect the metallic portions of the items contained within the storage container.

### III. OBJECTS OF THE INVENTION

It is the primary object of the present invention to provide chipboard segments that are impregnated with a volatile corrosive inhibitor suitable for placement in conjunction with the storage of metallic objects.

Another object of the present invention is to provide a corrosion inhibiting device consisting of an impregnated chipboard segment which will exude the volatile corrosion inhibiting chemicals over an extended period of time.

Still another object of the present invention is to provide a volatile corrosion inhibitor impregnated chipboard segment which may further include a coating along with at least one flat surface thereof in order to permit the imprinting of informational indicia thereon without at the same time effecting the ability of the segment to exude the corrosion inhibitor within the confines of the container containing metallic object.

Other objects of the present invention will become more apparent from the following description taken in conjunction with the accompanying drawings.

### IV. SUMMARY OF THE INVENTION

The present invention is a corrosion inhibiting device suitable for use in connection with storage boxes or other closed environments where metallic objects are stored in order to protect such metallic objects from the corrosive effects of moisture in the form of rust. According to the present invention, the device takes the form of a chipboard segment which is impregnated with volatile corrosion inhibitors along both surfaces thereof, and applied in such a manner as to permit the corrosion inhibitors to impregnate and attach themselves to the fibers of the chipboard. The chipboard is then dried and when positioned in a closed environment, such as a storage box or tool box, will commence exuding the corrosion inhibitors in the form of vapors which protect the metallic objects from the corrosive effect of moisture.

In the preferred embodiment, the chipboard segments will have dimensions approximating not less than 1/16th inch in thickness, although the same may be as much as an ⅛th inch in thickness. The width and length of each chipboard segment may be selected in accordance with the use to which the segment will be applied.

Further, it has been found that the chipboard segment may be covered with a clay coating, or other similar permeable membrane in order to permit the imprinting thereon of informational indicia, without at the same time effecting the ability of the corrosion inhibitors to permeate through and exude from the chipboard in order to provide their protective effect.

### V. BRIEF DESCRIPTION OF THE DRAWINGS

The description of the preferred embodiment of the invention will be better understood with reference to the following figures:

FIG. 1, represents a side cross sectional view in elevation, and enlarged, of a chipboard segment of the present invention impregnated with a volatile corrosion inhibitor.

FIG. 2 is a side view depicting in substance, the process of creating the impregnated chipboard of the present invention.

FIG. 3 is a side cross sectional view, in elevation, showing a chipboard segment of the present invention impregnated with a volatile corrosion inhibitor, and further including a clay coating along one surface thereof.

FIG. 4 is a top plan view, partly broken away showing a chipboard segment with indicia imprinted thereon.

### VI. DETAILED DESCRIPTION OF THE INVENTION

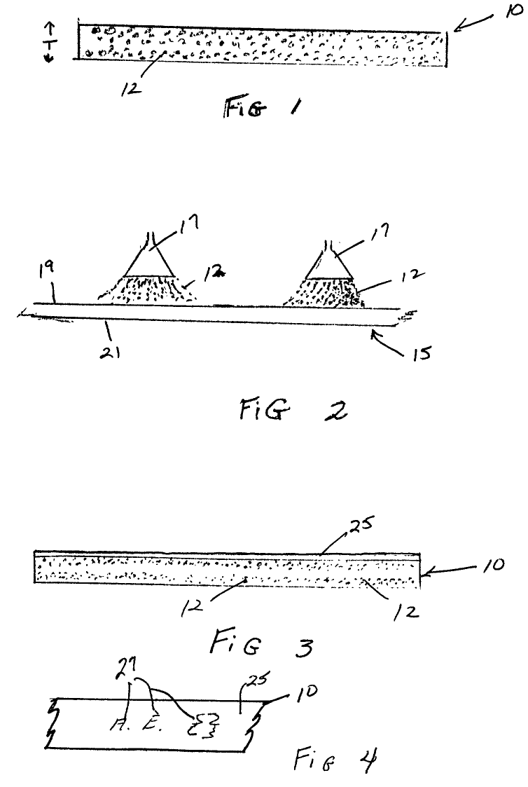

Viewing FIG. 1, there is illustrated a typical chipboard segment 10 in accordance with the present invention. The chipboard segment 10 is shown to be impregnated by a volatile corrosion inhibiting material 12. As illustrated in FIG. 1, the corrosion inhibiting material is in the form of chemical molecules which become imbedded in the chipboard segment 10. In order to accomplish the impregnation of the chipboard segment 10, the process employed is schematically illustrated in FIG. 2.

In FIG. 2, there is shown a typical chipboard segment in the form of a chipboard sheet 15 which is passed under one or more spray heads 17. The spray heads 17 are connected to an appropriate reservoir containing the corrosion inhibiting material in chemical form. The spray heads 17 create a spray of the corrosion inhibiting material 12 which is applied to the top surface 19 of the chipboard sheet 15.

Once the sheet has been passed under the spray head 17 on a first pass, the sheet is then dried in an appropriate heater device, which causes the fluid carrying material to evaporate leaving the corrosion inhibiting material 12 impregnated into the chipboard sheet 15. To complete the process, the chipboard is then reversed, and it is again passed under the spray head 17 so that the spray of corrosion inhibiting material 12 will impregnate the reverse side 21 of the chipboard sheet 15. Upon completion of the second spray pass, the chipboard sheet 15 is then dried once again leaving the chipboard sheet 15 with the corrosion inhibiting molecules 12 impregnated therein as depicted in FIG. 1.

It has been found that the corrosion inhibiting material 12 will in fact impregnate the chipboard sheet 15 virtually throughout. By spraying both surfaces 19 and 21 respectively of the chipboard sheet 15, total impregnation is achieved. It has been found that the impregnation occurs because the chipboard sheet 15 is generally formed of a loose fibrous material, as is well known in the art. Hence, the corrosion inhibiting material is able to penetrate into the fibers of the chipboard and be encapsulated therein. Further, it is well known that chipboard sheets are fibrous in nature, and therefore, when the chipboard segment 10 is put to its ultimate use, the molecules of corrosion inhibiting material are able to pass through the chipboard material and be released into the environment surrounding the chipboard. The corrosion inhibiting material is then actually released in the form of vapors which chemically combine with moisture in order to eliminate the moisture and prevent rusting of the metallic objects located in the immediate surrounds.

With reference to FIG. 3, and as an additional feature of the present invention, the chipboard segment 10 may further be coated with a clay material 25 which is porous in nature. The clay material dries to a fairly smooth finish and is white in color. This permits the printing of any type of indicia 27 onto the top surface thereof and thereby permits the manufacturer to imprint logos or other material pertinent to the product involved. As shown in FIG. 4, the one surface of the chipboard segment 10 includes the clay coating 25 thereon, and printed indicia 27 imprinted on the clay coating 25.

Dimensionally, it has been found that when the chipboard segments 10 have a thickness of between 1/16th inch and ⅛th inch, that the impregnation process works well, and the chipboard segment 10 is thoroughly impregnated. Further, it has been found that a segment thickness of 1/16th to ⅛th inch works well in terms of permitting the corrosion inhibiting material to be exuded from the chipboard segment 10 when it is in an enclosed environment.

The length and width of each chipboard segment may be cut to any particular length and width which the end user would find acceptable for their particular application. It has been found that an ideal measurement for use in connection with tool boxes or tackle boxes will be a chipboard segment 10 measuring somewhere between three and four inches in length, and approximately one inch in width. A chipboard segment 10 dimensionally sized as indicated will usually conveniently fit in the compartments formed in tackle boxes and or tool boxes, and yet has a sufficient overall dimension to provide a fairly long life in terms of its ability to continue to exude corrosion inhibiting material for extended use in the environment.

It will therefore be appreciated that the present invention provides an improved chipboard segment impregnated with a corrosion inhibiting material. The chipboard segment of the present invention is particularly adapted for use in connection with closed environments such as box enclosures which contain metallic objects including fishing tackle boxes, tool boxes, or other enclosed containers wherein metal objects are stored. The chipboard segment of the present invention is completely impregnated with a corrosion inhibiting material and when in use, it will exude the corrosion inhibitors in the form of vapors which remove the moisture from the environment of the enclosed container.

Further, since the chipboard segments are individual cardboard like items, they may be used until exhausted, and then easily replaced with additional chipboard segments without any installation requirements. Hence, the chipboard segments of the present invention provide the user with an easy to use format for corrosion inhibiting application after any product is first purchased.

Other application would include golf club cases, other sports equipment cases wherein the metallic equipment is stored for extended periods of time, especially in climatic conditions which include moisture.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

1 A corrosion inhibiting device intended for use in a closed environment which contains metallic objects, to aid in the control and the prevention of corrosion damage to such metallic objects stored therein, comprising,
a chipboard segment,
said chipboard segment formed from a porous permeable fibrous material and having a top surface, bottom surface, and a relatively small thickness, and said chipboard segment being impregnated with a corrosion inhibiting material such that said corrosion inhibiting material becomes interspersed within the fibrous material forming said chipboard segment,
whereby said impregnated chipboard segment, when placed in a closed environment containing metallic objects, will exude corrosion inhibiting vapors to aid in the control and prevention of corrosion damage to any metallic objects contained therein.

2 The corrosion inhibiting device as set forth in claim 1 above, wherein said chipboard segment has a thickness of between 1/16th and ⅛th inch.

3 The corrosion inhibiting device as set forth in claim 1 above, wherein said chipboard segment further includes a porous clay coating formed on the top surface of said chipboard segment.

4 The corrosion inhibiting device as set forth in claim 3 above, wherein said clay coating is relatively smooth and adapted to permit indicia to be imprinted thereon.
